(19) United States
(12) Patent Application Publication
(10) Pub. No.: US 2012/0056607 A1
(43) Pub. Date: Mar. 8, 2012

(54) Power Regulator, Power Control System and Method Thereof

(76) Inventor: Chin-Yi Lin, Dali City (TW)

(21) Appl. No.: 12/877,290

(22) Filed: Sep. 8, 2010

(51) Int. Cl. G05F 1/46

(52) U.S. Cl. 323/293

(57) ABSTRACT

A power regulator, power control system and the method thereof are provided. A detecting device receives a feedback signal from a resistive load device, and outputs a control signal, which could be a voltage or a current. While receiving the control signal, the power regulator outputs a drive voltage in a proportional way. In the proportional way, full power drive voltage is outputted in a continuous output time period and is stopped outputting in a continuous non-output time period. The resistive load device receives the drive voltage and then outputs the feedback signal to the detecting device. Similarly, in the proportional way, the full power drive voltage is outputted in the continuous output time period and is stopped outputting in the continuous non-output time period. Thus, it is able to decrease the amount of harmonic waves.

### BACKGROUND OF THE INVENTION

1. Field of the Invention

The exemplary embodiment(s) of the present invention relates to a power regulator, a power control system and the method thereof. More specifically, the exemplary embodiment(s) of the present invention relates to a device, system and the method for low harmonic wave power quality control to reduce harmonic wave function and capable of outputting a full power driving voltage at a continuous output time interval and stopping outputting of the full power driving voltage at the continuous non-output time interval through a proportion manner.

2. Description of the Related Art

In many power quality control systems, most systems take the power required for asymmetric output as the priority. The frequently used method includes distributed type zero set control and straight-line phase control. Both control methods usually take full or half waves as a unit to output driving voltages. With reference to FIG. 1 to FIG. 3, taking zero set control as an example, the state of interrupt frequency at the highest driving voltage is that when the output power of driving voltage is 50% (FIG. 2), the interrupt frequency is one half of outputted alternating current frequency. With reference to FIG. 4 to FIG. 6, taking the straight-line phase control as an example, while outputting and operating at non-full power, the outputted driving voltage is that the voltage magnitude of each positive and negative half period phase angle is taken as the magnitude variation of voltage output. The currently applied methods may cause much harmonic wave.

The driving voltage outputted by a power regulator takes the positive and negative half period phase angle to output or discontinuously output with respect to the driving voltages. The circuit may form harmonic wave interference to damage equipment. Consequently, the problem of the product life of the electronic equipment or increasing the utilization efficiency of the equipment needs to be overcome.

### SUMMARY OF THE INVENTION

In view of the shortcomings of the prior art, the inventor of the present invention based on years of experience in the related industry to conduct extensive researches and experiments, and finally developed a power regulator, a power control system and the method thereof to overcome the problem caused by harmonic waves.

Therefore, it is a primary objective of the present invention to overcome the aforementioned shortcoming and deficiency of the prior art by providing a power regulator, a power control system and the method thereof.

To achieve the foregoing objective, the power control system comprises a resistive loading device, a detecting device and a power regulator. The resistive loading device receives a driving voltage to perform a corresponding operation. At least one feedback signal is generated based upon characteristics of the resistive loading device that is detected after operation. The features that are detected include temperatures, moistures or pressures. After the feedback signal is transmitted to the detecting device from the resistive loading device, the detecting device converts the feedback signal into a plurality of control signals. After the control signals are transmitted to the power regulator from the detecting device, an average value of the control signals within the first time interval is computed. A corresponding driving voltage within a second time interval is outputted based upon the average value. The second time interval includes a continuous output time interval and a continuous non-output time interval. A proportion occupied by the continuous output time interval and the continuous non-output time interval is distributed from the average value of the control signals. A full power driving voltage is continuously outputted at the continuous output time interval, and the full power driving voltage is stopped outputting at the continuous non-output time interval. Accordingly, the minimum harmonic waves are generated for the whole power system.

The power regulator comprises a trigger unit, a microcomputer processing unit, a power unit, and a signal input unit. The trigger unit receives the trigger signal outputted by the microcomputer processing unit, and a voltage signal is outputted as the driving voltage based upon the trigger signal. The power unit provides power required for the power regulator. The signal input unit receives the control signals and converting the control signals into a plurality of high-low electric potential percentage control signals. The high-low electric potential percentage control signals then are transmitted to the microcomputer processing unit. The microcomputer processing unit computes an average value of the high-low electric potential percentage control signals within a fixed time and generates the trigger signal based upon the average value. The trigger signal is that a proportion between the continuous output time interval and the continuous non-output time interval is distributed according to the average value of the high-low electric potential percentage control signals to continuously output a full power trigger signal at the continuous output time interval and to stop outputting the full power trigger signal at the continuous non-output time interval.

To achieve the foregoing objective, a power control method is provided. The method comprises the following steps of firstly utilizing a resistive loading device to generate at least one feedback signal that is transmitted to a detecting device. After receiving at least one feedback signal through the detecting device, the feedback signal is respectively converted into a plurality of control signals that is outputted to a power regulator. After receiving the control signals within a first time interval, the power regulator computes an average value of the control signals. The power regulator outputs a driving voltage within a second time interval based upon the average value of each control signal. The second time interval includes a continuous output time interval and a continuous non-output time interval. A proportion between the continuous output time interval and the continuous non-output time interval is distributed according to the average value of the control signals to continuously output a full power driving voltage at the continuous output time interval and to stop outputting the full power driving voltage at the continuous non-output time interval.

The power regulator comprises a trigger unit, a microcomputer processing unit, a power unit, and a signal input unit. The trigger unit receives the trigger signal outputted by the microcomputer processing unit, and a voltage signal is outputted as the driving voltage based upon the trigger signal. The power unit provides power required for the power regulator. The signal input unit receives the control signals and converts the control signals into a plurality of high-low electric potential percentage control signals. The high-low electric potential percentage control signals then are transmitted to the microcomputer processing unit. The microcomputer processing unit computes an average value of the high-low electric potential percentage control signals within a fixed time and generates the trigger signal based upon the average value. The trigger signal is that a proportion between the continuous output time interval and the continuous non-output time interval is distributed according to the average value of the high-low electric potential percentage control signals to continuously output a full power trigger signal at the continuous output time interval and to stop outputting the full power trigger signal at the continuous non-output time interval.

To achieve the foregoing objective, a power regulator is further provided and comprises a power unit, a signal input unit, a microcomputer processing unit and a trigger unit. The power unit provides power required for the power regulator. The signal input unit receives the control signals and converting the control signals into a plurality of high-low electric potential percentage control signals respectively. The microcomputer processing unit is connected to the power unit and the signal input unit to receive the high-low electric potential percentage control signals. The microcomputer processing unit computes an average value of the high-low electric potential percentage control signals within a first time interval and generates a trigger signal within a second time interval according to the high-low electric potential percentage control signals. The trigger signal is that a proportion between the continuous output time interval and the continuous non-output time interval of the second time interval is distributed according to the average value of each high-low electric potential percentage control signal to continuously output a full power trigger signal at the continuous output time interval and to stop outputting the full power trigger signal at the continuous non-output time interval. The trigger unit is connected to the microcomputer processing unit to receive the trigger signal and outputs a voltage signal as a driving voltage based upon the trigger signal.

The power regulator, power control system and the method thereof have the following advantages: the power regulator, power control system and its method could output the full power driving voltage at the continuous output time interval and stop outputting the full power driving voltage at the continuous non-output time interval through a proportion manner, thereby reducing the generation of harmonic waves.

### BRIEF DESCRIPTION OF THE DRAWINGS

FIG. 1 is a waveform of a driving voltage of a conventional distributed type zero set control (The driving voltage is 10%);

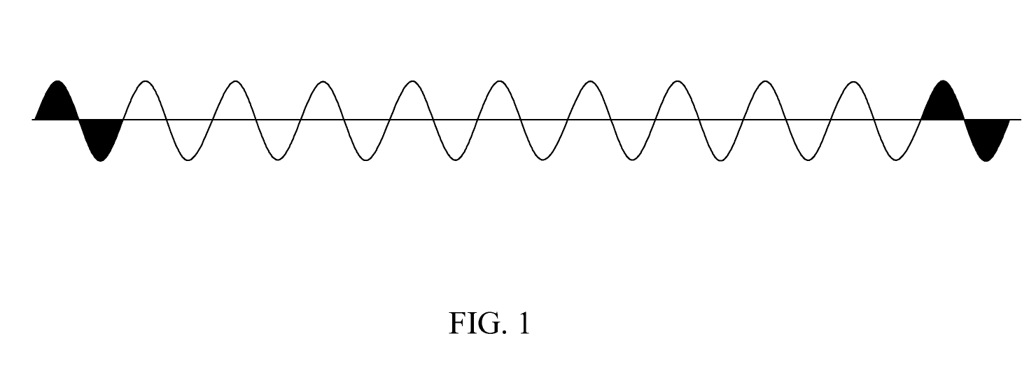

FIG. 2 is a waveform of a driving voltage of a conventional distributed type zero set control (The driving voltage is 50%);

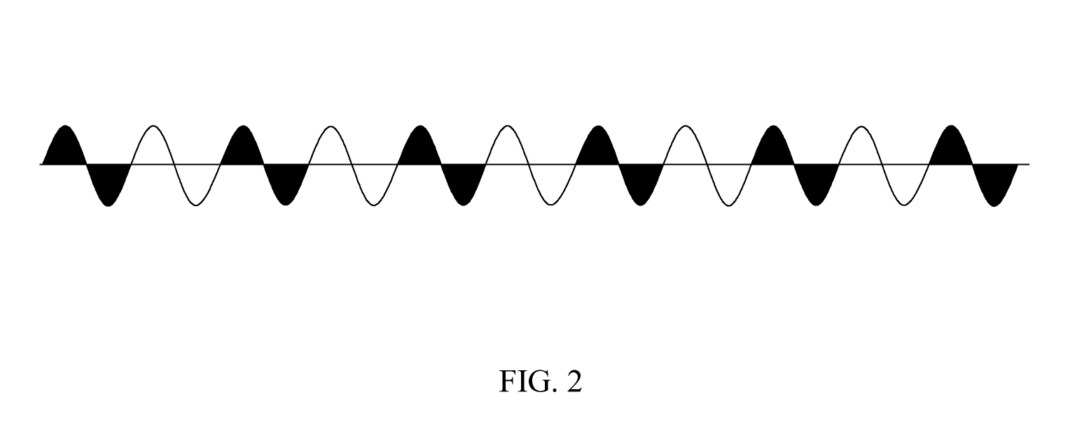

FIG. 3 is a waveform of a driving voltage of a conventional distributed type zero set control (The driving voltage is 90%);

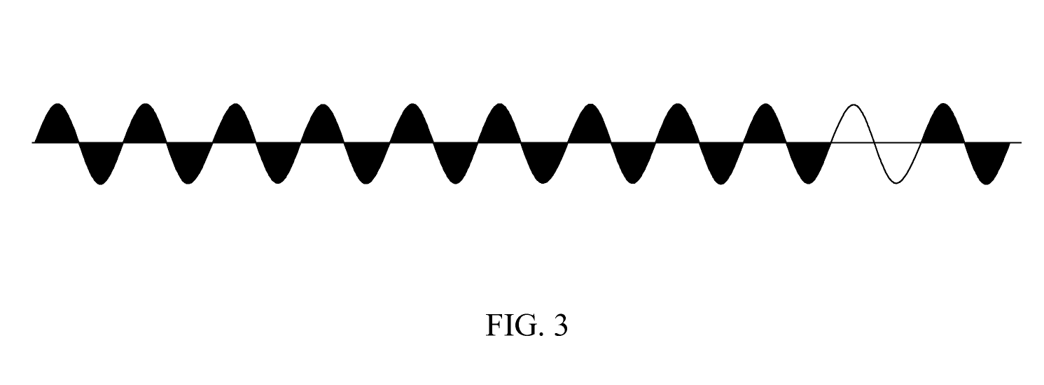

FIG. 4 is a waveform of a driving voltage of a conventional straight-line type phase control (The driving voltage is 10%);

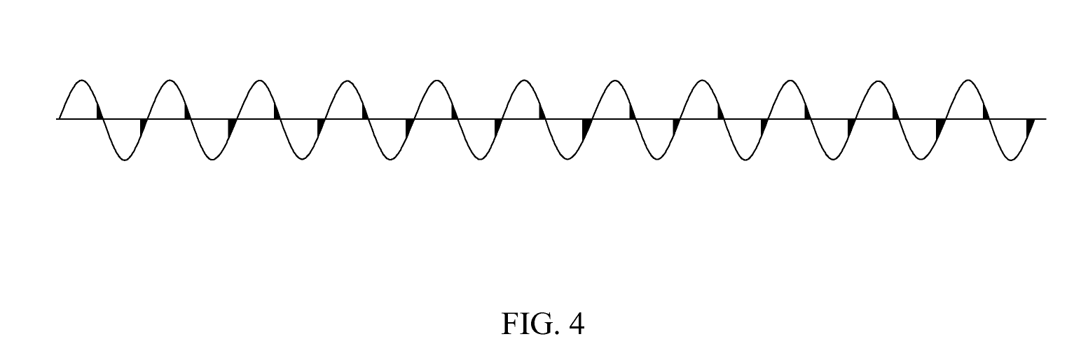

FIG. 5 is a waveform of a driving voltage of a conventional straight-line type phase control (The driving voltage is 50%);

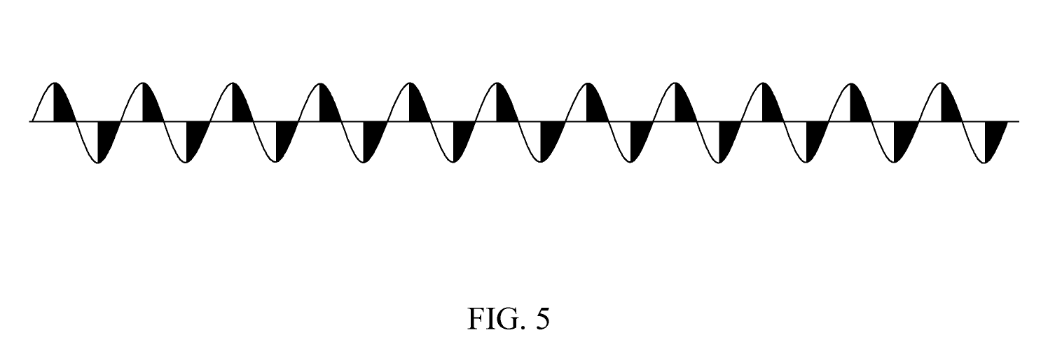

FIG. 6 is a waveform of a driving voltage of a conventional straight-line type phase control (The driving voltage is 90%);

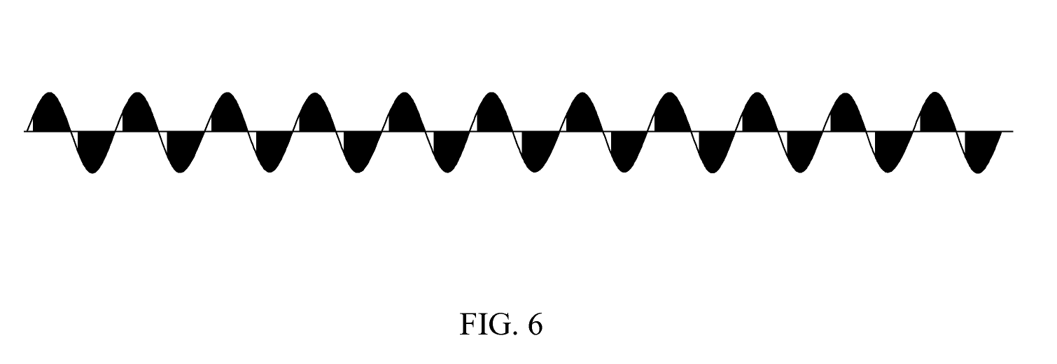

FIG. 7 is a block diagram of a power control system according to a present invention;

FIG. 8A is a block diagram of a three phase power regulator of a power control system according to a present invention;

FIG. 8B is a block diagram of a unidirectional power regulator according to a present invention;

FIG. 9 is a schematic diagram showing that a driving voltage is 10% while a second time interval is 100 cycle according to a present invention;

FIG. 10 is a schematic diagram showing that a driving voltage is 50% while a second time interval is 100 cycle according to a present invention;

FIG. 11 is a schematic diagram showing that a driving voltage is 90% while a second time interval is 100 cycle according to a present invention; and

FIG. 12 is a flowchart of an implementation steps of a power control method according to a present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

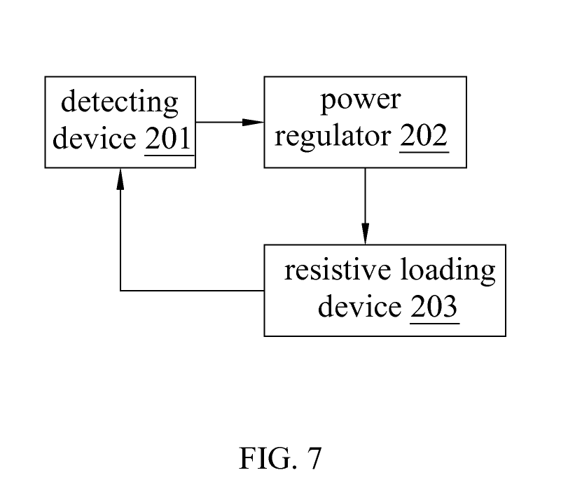

With reference to FIG. 7 for a block diagram of a power control system in accordance with the present invention is depicted. As shown in the figure, the power control system comprises a detecting device 201, a power regulator 202 and a resistive loading device 203. The detecting device 201 outputs a control signal to the power regulator 202 after receiving a feedback signal of the resistive loading device 203. The power regulator 202 outputs different powers to the resistive loading device 203 based upon the control signal. The resistive loading device 203 then transmits feedback data to the detecting device 201.

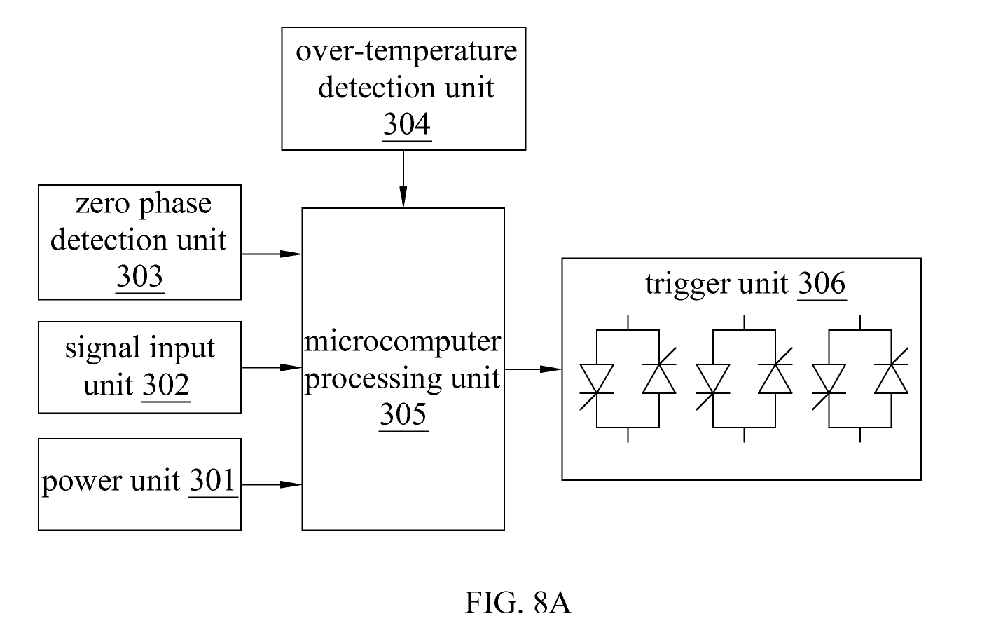

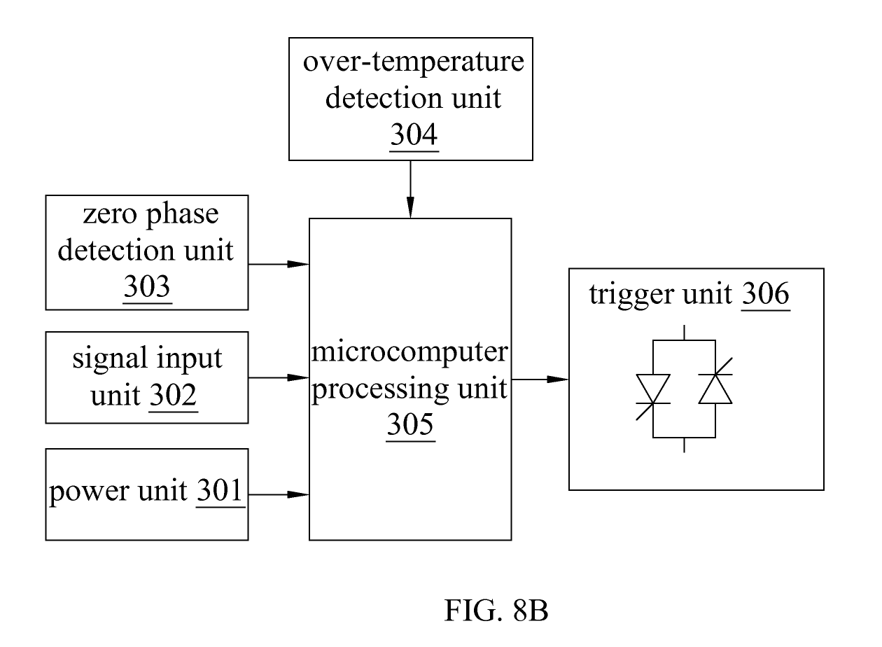

With reference to FIG. 8A for a block diagram of a three phase power regulator of the power control system in accordance with the present invention is depicted. As shown in the figure, the power regulator comprises a power unit 301, a signal input unit 302 and a zero phase detection unit 303, an over temperature detection unit 304, a microcomputer processing unit 305, and a trigger unit 306. The trigger unit 306 comprises multiple sets of rectifiers. Each set of rectifier comprises two silicon-controlled rectifiers reversely connected in parallel. The microcomputer processing unit 305 is connected to the power unit 301, the signal input unit 302, the zero phase detection unit 303, the over temperature detection unit 304, and the trigger unit 306. The power unit 301 supplies power required for the power regulator. The signal input unit 302 could receive control signals of voltages or currents. Its voltage signals are 0V to 5V, 1V to 5V, 0V to 10V, and 2V to 10V. The current signals are 0 mA to 20 mA or 4 mA to 20 mA. If the control signals are an electric current, the signal input unit 302 converts the electric current into a voltage signal and outputs the voltage signal. The signal input unit 302 outputs a high-low electric potential percentage control signal to the microcomputer processing unit 305 after converting the control signals. The high-low electric potential percentage control signals comprise the control signal of the voltage signal converted from the electric current and the control signal which is originally the voltage signal.

The over-temperature detection unit 304 measures whether or not the temperature inside the power regulator is higher than a predetermined value. If the temperature is higher than the predetermined value, an over temperature control signal is sent to the microcomputer processing unit 305. The microcomputer processing unit 305 actuates a fan. The fan is located at a side of the power control system. The trigger unit 306 receives the trigger signal sent from the microcomputer processing unit. The multi-phase voltage signal is conducted after triggering the plurality of rectifier sets based upon the trigger signal, and the multi-phase voltage signal is outputted as the driving voltage. In the plurality of rectifier sets, each set of rectifier comprises two silicon-controlled rectifiers reversely connected in parallel. The zero phase detection unit 303 outputs the zero point position of the multi-phase voltage signal to the microcomputer processing unit 305. The microcomputer processing unit 305 will take an average value of all received high-low electric potential percentage control signals at a time interval as a basis to send the trigger signal while receiving the high-low electric potential percentage control signals.

With reference to FIG. 8B for a block diagram of a single phase power regulator of a power control system in accordance with the present invention is depicted. In the figure, the single phase power regulator is approximately similar to the three phase power regulator. Both differences are that the trigger unit 306 merely comprises a single set rectifier. The trigger unit 306 receives the trigger signal sent from the microcomputer processing unit. The single phase voltage signal is conducted after triggering the single set rectifier based upon the trigger signal, and the single phase voltage signal is outputted as a driving voltage. The single set rectifier comprises two silicon-controlled rectifiers reversely connected in parallel. The zero phase detection unit 303 outputs the zero point position of the single phase voltage signal to the microcomputer processing unit 305. The microcomputer processing unit 305 will take an average value of all received high-low electric potential percentage control signals at a time interval as a basis to send the trigger signal while receiving the high-low electric potential percentage control signals.

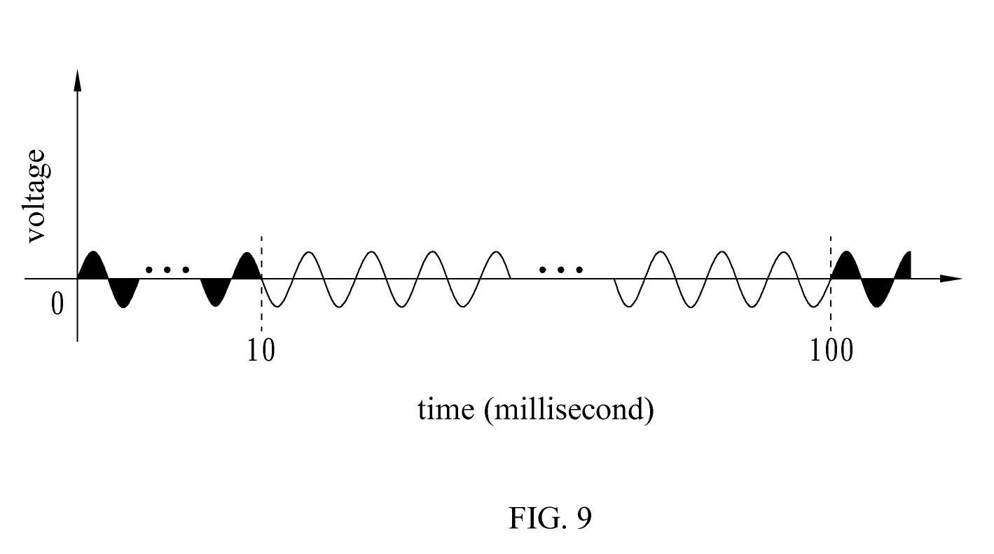

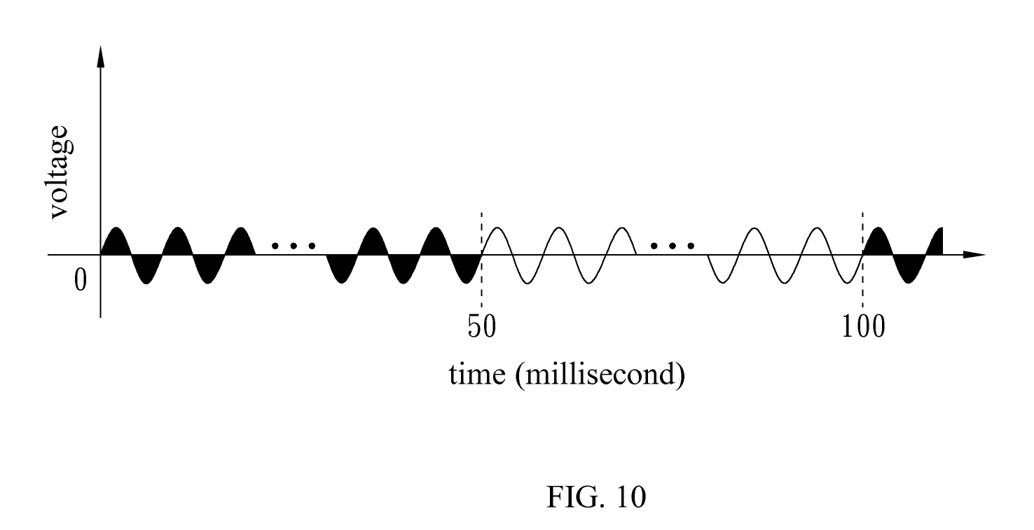

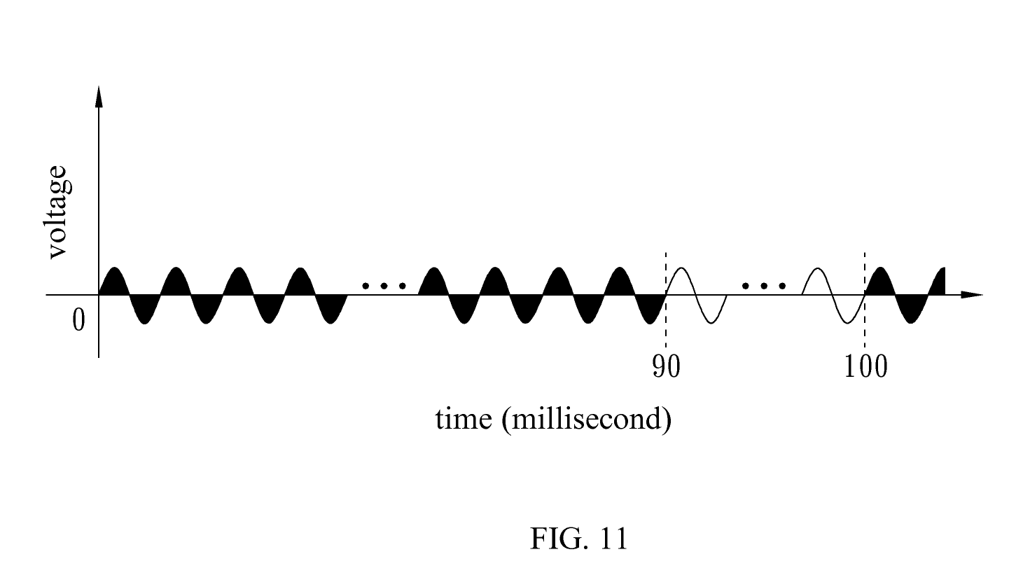

With reference to FIG. 9 to FIG. 11 for outputted diagrams of driving voltages in accordance with the present invention, waveforms formed under different driving voltages are depicted. In the figures, the waveforms include an entire black waveform formed by outputting full power driving voltages, and a hollow waveform formed by stopping the outputting of the full power driving voltage. As shown in FIG. 9, when each time interval has 100 cycles, the power output is 10%. Only 10 cycles have the full power driving voltage, and other 90 cycles are to stop outputting the full power driving voltage. As shown in FIG. 10, when the power output is 50%, 50 cycles represent the full power driving voltage in advance. Other 50 cycles are to stop outputting the full power driving voltage. As shown in FIG. 11, when the power output is 90%, 90 cycles represent the full power driving voltage. Other 10 cycles are to stop outputting the full power driving voltage. Accordingly, in each unit time, only one time change from outputting the full power driving voltage to stop outputting the full power driving voltage. The setting of the continuous output time interval and the continuous non-output time interval enables the controller to have many sets of unit times capable of being selected.

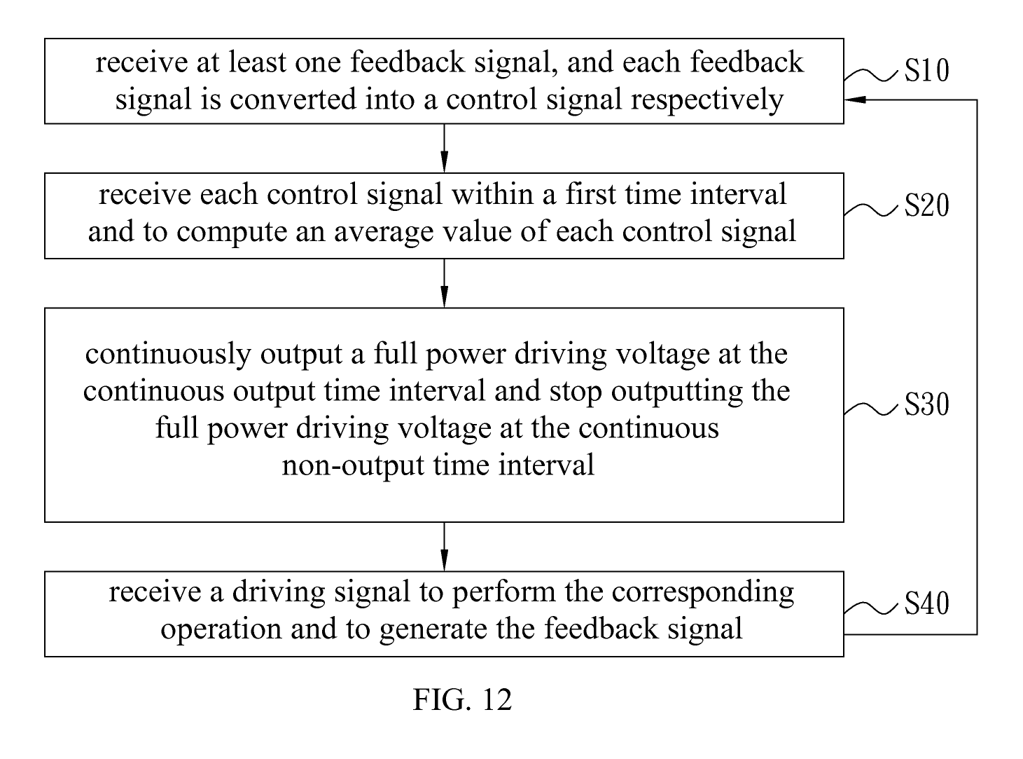

With reference to FIG. 12 for a flowchart of an implementation of a power control method in accordance with the present invention, the power control method comprises the following steps:

In step S10, a detecting device is utilized to receive at least one feedback signal, and each feedback signal is converted into a control signal respectively.

In step S20, a power regulator is utilized to receive each control signal within a first time interval and to compute an average value of each control signal.

In step S30, the power regulator is used to output the driving voltage within a second time interval based upon the average value, and a proportion between the continuous output time interval and the continuous non-output time interval is distributed according to the average value to continuously output a full power driving voltage at the continuous output time interval and to stop outputting the full power driving voltage at the continuous non-output time interval.

In step S40, a resistive loading device is utilized to receive a driving signal to perform the corresponding operation and to generate the feedback signal based upon the characteristic of the resistive loading device.

With reference to Table 1 for a proportion between the fundamental and the root mean square (RMS) total of harmonic wave under the condition of outputting the full power driving voltage at the continuous output time interval and stopping the outputting of the full power driving voltage at the continuous non-output time interval through the proportion manner is depicted. While operating at 30% of driving voltage, total harmonic distortion ratio of RMS total is 2.91%, and total harmonic distortion ratio of fundamental is 2.92%. While operating at 50% of driving voltage, total harmonic distortion ratio of RMS total is 3.24%, and total harmonic distortion ratio of fundamental is 3.24%. With reference to Table 2 for a proportion between the fundamental and the root mean square (RMS) total of harmonic wave under the distributed type zero set control is depicted. While operating at 30% of driving voltage, total harmonic distortion ratio of RMS total is 18.81%, and total harmonic distortion ratio of fundamental is 18.36%. While operating at 50% of driving voltage, total harmonic distortion ratio of RMS total is 18.74%, and total harmonic distortion ratio of fundamental is 18.37%. Data recorded in the both tables obviously shows that harmonic waves are greatly reduced under the condition of outputting the full power driving voltage at the continuous output time interval and stopping the outputting of the full power driving voltage at the continuous non-output time interval through the proportion manner. Therefore, the experiment matches the theory.

TABLE 1
harmonic waves are generated under the condition of outputting
the full power driving voltage at the continuous output time interval and
stopping the outputting of the full power driving voltage at the continuous
non-output time interval through the proportion manner.

| | (THD-R total harmonic | (THD-F total harmonic |
|---|---|---|
| | distortion as % of RMS | distortion as % of |
| proportion | total) | fundamental) |
| 30% of driving | 2.91% | 2.92% |
| voltage | | |
| 50% of driving | 3.24% | 3.24% |
| voltage | | |

TABLE 2
harmonic waves are generated by the power regulator under the
condition of distributed type zero set control.

| | (THD-R total harmonic | (THD-F total harmonic |
|---|---|---|
| Distributed type zero | distortion as % of RMS | distortion as % of |
| set control | total) | fundamental) |
| 30% of driving | 18.81% | 18.36% |
| voltage | | |
| 50% of driving | 18.74% | 18.37% |
| voltage | | |

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A power control system comprising:
a detecting device receiving at least one feedback signal and converting the at least one feedback signal into a plurality of control signals respectively;
a power regulator connected to the detecting device for receiving the control signals respectively, obtaining an average value of the control signals within a first time interval, and outputting a driving voltage within a second time interval based upon the average value, the second time interval comprising a continuous output time interval and a continuous non-output time interval, the power regulator further distributing a proportion between the continuous output time interval and the continuous non-output time interval based upon the average value of the control signals to continuously output a full power driving voltage at the continuous output time interval and to stop outputting the full power driving voltage at the continuous non-output time interval; and
a resistive loading device connected to the detecting device and the power regulator for receiving the driving voltage outputted by the power regulator to perform a corresponding operation and generating the feedback signal based upon a feature of the resistive loading device that is detected.

2. The power control system as recited in claim 1, wherein each of the control signals is a voltage value that is between 0 and 5 volts, 0 and 10 volts, 1 and 5 volts or 2 and 10 volts, and each of the control signals is a current value that is between 0 and 20 milliamperes or 4 and 20 milliamperes.

3. The power control system as recited in claim 1, the power regulator further comprising:
a power unit supplying a power required by the power regulator;
a signal input unit receiving the control signals and converting the control signals into a plurality of high-low electric potential percentage control signals respectively;
a microcomputer processing unit connected to the power unit and the signal input unit for computing an average value of the high-low electric potential percentage control signals, receiving the high-low electric potential percentage control signals, and generating a trigger signal based upon the high-low electric potential percentage control signals, the trigger signal distributing a proportion between the continuous output time interval and the continuous non-output time interval according to the average value of the high-low electric potential percentage control signals to continuously output a full power trigger signal at the continuous output time interval and to stop outputting the full power trigger signal at the continuous non-output time interval; and
a trigger unit connected to the microcomputer processing unit for receiving the trigger signal and outputting a voltage signal as the driving voltage based upon the trigger signal.

4. The power control system as recited in claim 3, wherein the trigger unit further comprises at least one set of rectifier; the rectifier corresponds to a number of the voltage signal, and the set of rectifier comprises two silicon-controlled rectifiers reversely connected in parallel; the voltage signal is conducted to output the driving voltage after triggering the set of rectifier based upon the trigger signal.

5. A power control method comprising following steps:
utilizing a detecting device to receive at least one feedback signal and convert the at least one feedback signal into a plurality of control signals;
utilizing a power regulator to receive the control signals within a first time interval, to calculate an average value of the control signals, and to output a driving voltage within a second time interval based upon the average value through the power regulator, the second time interval comprising a continuous output time interval and a continuous non-output time interval, and distributing a proportion between the continuous output time interval and the continuous non-output time interval based upon the average value to continuously output a full power driving voltage at the continuous output time interval and to stop outputting the full power driving voltage at the continuous non-output time interval; and
receiving the driving voltage through a resistive loading device to perform a corresponding operation, and generating the feedback signal based upon a characteristic of the resistive loading device.

6. The power control method as recited in claim 5, wherein the power regulator comprises:
a power unit providing power required for the power regulator;
a signal input unit receiving the control signals and converting the control signals into a plurality of high-low electric potential percentage control signals respectively;
a microcomputer processing unit connected to the power unit and the signal input unit for computing an average value of the high-low electric potential percentage control signals, receiving the high-low electric potential percentage control signals, and generating a trigger signal based upon the high-low electric potential percentage control signals, the trigger signal distributing a proportion between the continuous output time interval and the continuous non-output time interval according to the average value of the high-low electric potential percentage control signal to continuously output a full power trigger signal at the continuous output time interval and to stop outputting the full power trigger signal at the continuous non-output time interval; and
a trigger unit connected to the microcomputer processing unit for receiving the trigger signal and outputting a voltage signal as the driving voltage based upon the trigger signal.

7. The power control method as recited in claim 6, wherein the trigger unit further comprises at least one set of rectifier; the rectifier corresponds to a number of the voltage signal, and the set of rectifier comprises two silicon-controlled rectifiers reversely connected in parallel; the voltage signal is conducted to output the driving voltage after triggering the set of rectifier based upon the trigger signal.

8. A power regulator comprising:
a power unit providing a power required for the power regulator;
a signal input unit receiving at least one control signal and converting the at least one control signal into a plurality of high-low electric potential percentage control signals;
a microcomputer processing unit connected to the power unit and the signal input unit for receiving the high-low electric potential percentage control signals, computing an average value of the high-low electric potential percentage control signals within a first time interval, and generating a trigger signal within a second time interval based upon the high-low electric potential percentage control signals, the trigger signal distributing a proportion between a continuous output time interval and a continuous non-output time interval according to the average value of the high-low electric potential percentage control signals to continuously output a full power trigger signal at the continuous output time interval and to stop outputting the full power trigger signal at the continuous non-output time interval; and
a trigger unit connected to the microcomputer processing unit for receiving the trigger signal and outputting a voltage signal as a driving voltage based upon the trigger signal.

9. The power regulator as recited in claim 7, wherein the trigger unit further comprises at least one set of rectifier; the rectifier corresponds to a number of the voltage signal, and the set of rectifier comprises two silicon-controlled rectifiers reversely connected in parallel; the voltage signal is conducted to output the driving voltage after triggering the set of rectifier based upon the trigger signal.
